(19) United States
(12) Patent Application Publication
(10) Pub. No.: US 2015/0052062 A1
(43) Pub. Date: Feb. 19, 2015

(54) E-COMMERCE SHOPPING AND PAYMENT PROCESS

(71) Applicants: Igor Flomin, Los Angeles, CA (US); Alex Flomin, Elizabeth, NJ (US)

(72) Inventors: Igor Flomin, Los Angeles, CA (US); Alex Flomin, Elizabeth, NJ (US)

(21) Appl. No.: 14/294,085

(22) Filed: Jun. 2, 2014

Related U.S. Application Data
(60) Provisional application No. 61/830,135, filed on Jun. 2, 2013.

(51) Int. Cl. G06Q 30/06; G06Q 20/34; G06Q 20/12; G06Q 20/38

(52) U.S. Cl. CPC G06Q 30/0633; G06Q 20/3829; G06Q 20/34; G06Q 20/12
USPC 705/71; 705/26.8

(57) ABSTRACT

A process that simplifies shopping on E-commerce platforms includes a program that naturally keeps sensitive user information and data more secure by removing large amounts of sensitive user information and data from multiple merchant sites. The process makes use of personal devices that are always available to users to store user, shipping and payment information and data. Transactions are completed by having the personal device communicate either directly with a merchant's gateway or merchant account, and then sending the transaction details and shipping information and data to both the user and the merchant.

### CROSS-REFERENCE TO RELATED APPLICATION

This application claims the benefit of U.S. Provisional Application No. 61/830,135 filed 2 Jun. 2013.

### REFERENCE REGARDING FEDERAL SPONSORSHIP

Not Applicable

### REFERENCE TO MICROFICHE APPENDIX

Not Applicable

### BACKGROUND

1. Field of the Invention

The present invention relates to E-commerce transactions and, in particular, to secure shopping and payment in such transactions. The associated software is provided to a user's smart phone, tablet, PC or similar device, for storing a list of participating member merchants and corresponding merchant bank/payment processors and facilitating payment via transfer of credit card, debit card, or bank account information directly to gateway processors or banks, thus avoiding revealing credit card or other sensitive confidential financial data to the merchant. While the software on a user's device does not necessarily store such a list, it is stored on a separate server.

2. Description of Related Art and Other Considerations

E-commerce has become part of almost everyone's lives. One reason for its popularity, among many others, is the convenience it offers to consumers. Consumers can shop for and purchase products or services from the comfort of their home. There are, however, still ways in which shopping at brick-and-mortar locations are more convenient. One such convenience is the ability of the user to quickly checkout and pay for his or her purchase by the simple swipe of his or her card. Another convenience is the security of the user's sensitive information and data such as embodied in his or her credit card. With online shopping, new users are required to fill out lengthy forms, and submit credit card information and data which is often stored on the merchant's database. While storing the user's payment information and data in a database offers the convenience of simpler checkout for future orders with the merchant, it also offers those with bad intent, such as hackers, a single location where potentially millions of user's private personal identifiable information and data may be compromised with a single attack.

It is one goal of the present invention not only to simplify the checkout process across all merchants online but also to reduce the possibility that large amounts of user's information and data (whether confidential or not) will be compromised in a single location and at any of the merchant's sites.

### BRIEF SUMMARY OF THE INVENTION

These and other of the aforesaid problems and considerations are successfully addressed and overcome by the present invention. A payment processing software is utilized and adapted to work as a desktop application, mobile application, web application, or browser add-on, all of which are hereinafter sometimes termed “application” or “the application.” Included are electronic devices including server apparati such as at least an application server. Such apparati means a server that does not belong to the user or a merchant and that is used by the application and merchant to forward information to the other, e.g. a merchant sends data to the server which sends the data to user's device, or the user's device sends data to the server which is then sent to the merchant's server.

If the device with the payment application is near the device or terminal where a user is shopping (using Global Positioning System (GPS)+Internet Protocol (IP) address location), the checkout process can be completed directly in the device or terminal where the user is shopping, by entering the password which is then sent to the device with the payment processing software.

For the product to work at physical locations (e.g., point of sale (POS) locations), users will be issued an electronic credit card which will send the details of the transaction, merchant, and merchandise to the payment processing device to complete the transaction.

The following steps are intended to be a brief summary of the invention and are not intended to limit its scope:
(A) A user installs a proprietary application (such as proprietary software or closed source software) on a device such as phone, tablet or computer. The user enters one identifier, such as a phone number or an email address, and a pin.
(B) A user's payment information and data, such as credit card, bank account, or other forms of payment, is stored locally in the application. The user's shipping profile or profiles will also be stored in the application.
(C) Online merchants implement a proprietary code in their online shopping systems.
(D) When individual users shop at online merchants that have implemented the code, such users add items to their respective carts as they normally would.
(E) When a user is ready to checkout, he or she enters one of his or her identifiers (such as a phone number or an email address) and a security code. The security code, or pin, is to protect the user from someone else adding items to the user's cart. Therefore, when shopping on a device that does not have the application installed, the user is required to enter an identifier and the pin. If a user is shopping on a computer and the application is installed and running, there would be no need for the user to enter an identifier or the pin since the user's identity is confirmed by the application that is running.
(F) When the online checkout process is completed, the user receives a notification via email, SMS (short message service), operating system specific notification, or other channel(s) that the user has when new items are added to the individual's cart. If the user is shopping on a computer and the application is installed and running, the user would be able to complete the checkout (payment and shipping options) directly within the merchant's website experience after clicking checkout on the site. The application would inject such content into the user's browser once the user clicks “checkout.” This injected content would essentially show the same experience as if the user sent the user's cart to another device (by continuing to the following step (step G) within the website at which the user is shopping.
(G) Each user has a variety of options where he or she can select the payment method selected for the items in his/her cart and the shipping address to which the products are to be mailed as provided in the application installed on his/her device.
(H) To complete the transaction and place the order, the user clicks the checkout button and enters the password for the payment method the user has selected. Since passwords are encryption keys for the payment methods and are never stored on the device, each payment method can have a different password.
(I) The application will communicate directly with a payment gateway or bank server but not through any other server. When the application receives a confirmation from the payment gateway or bank that it has received the payment information, the application then sends the order confirmation and the bank's response (e.g. unique token or hash assigned to that transaction) to the merchant's server for fulfillment. As used herein, “hash” is meant to define a function which is primarily used to generate fixed-length output data that acts as a shortened reference to the original data.

### BRIEF DESCRIPTION OF THE DRAWINGS

FIG. 1 shows an overview and flow of the working or steps of the inventive shopping and payment process.

FIGS. 2A and 2B show a more detailed overview of the inventive shopping and payment process.

FIG. 3 illustrates an alternate embodiment of the inventive shopping and payment process.

### DETAILED DESCRIPTION AND BEST MODE OF IMPLEMENTATION

In one embodiment, the present invention details a process that is a faster and more secure E-commerce system. Instead of storing sensitive data, such as passwords, credit card or bank account information, and data on online servers at merchant sites, the present invention allows for users to store their sensitive data locally on a personal device, such as a smart phone, tablet or computer. The server will store every user's unique identifiers, such as a phone number or email, security/pin code, and also temporarily store the user's cart to relay it to another device when the user is shopping. As to the password, it is used solely as an encryption key which, while not stored locally on a user's device, is manually entered on the device. The application then uses the password to temporarily decrypt the payment information and, after sending the payment information to the bank and all the other details required for the transaction, the application erases or otherwise omits the password and the decrypted data. The password may be a character combination, fingerprint, a retina scan, or a physical token such a universal serial bus (USB). The shopping cart can be a mobile application, tablet application, desktop application, or as a browser extension.

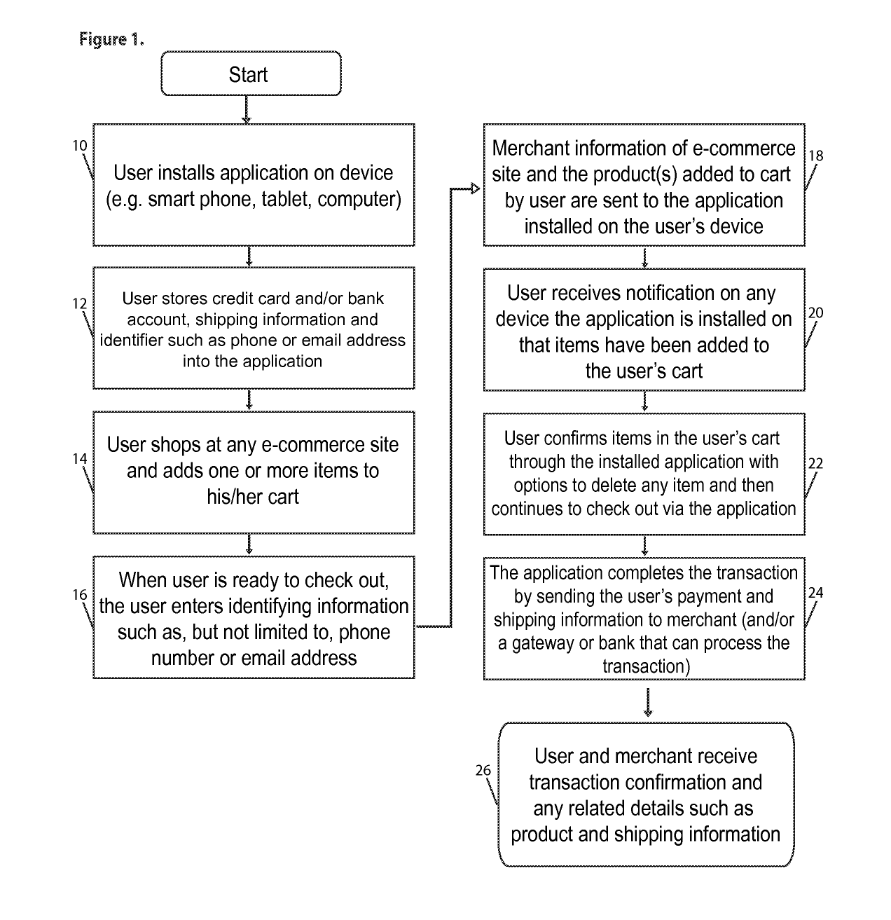

In one form of implementation as depicted in FIG. 1, as depicted in box 10 a user installs application on device (e.g., smart phone, tablet, computer). As shown in box 12, the user stores credit card and/or bank account, shipping information and identifier such as phone or email address into the application. As illustrated in box 14, the user then shops at any e-commerce site and adds one or more items to the user's cart. The user continues (box 16), when ready to check out, the user enters identifying information such as, but not limited to, phone number or email address. According to the step depicted in box 18, merchant information of e-commerce site and product(s) added to cart by user are sent to the application installed on the user's device. The user receives notification (box 20) on any device the application is installed on that items have been added to the user's cart. As directed in box 22, the user confirms the item(s) in the user's cart through the installed application with options to delete any item and then continues to check out via the application. With reference to (box 24), the application completes the transaction by sending the user's payment to a payment processor (a gateway or a bank) and the shipping information to the relevant merchant, thus processing the transaction. The final step, as illustrated in box 26, has the user and merchant receive transaction confirmation and any related details such as product and shipping information.

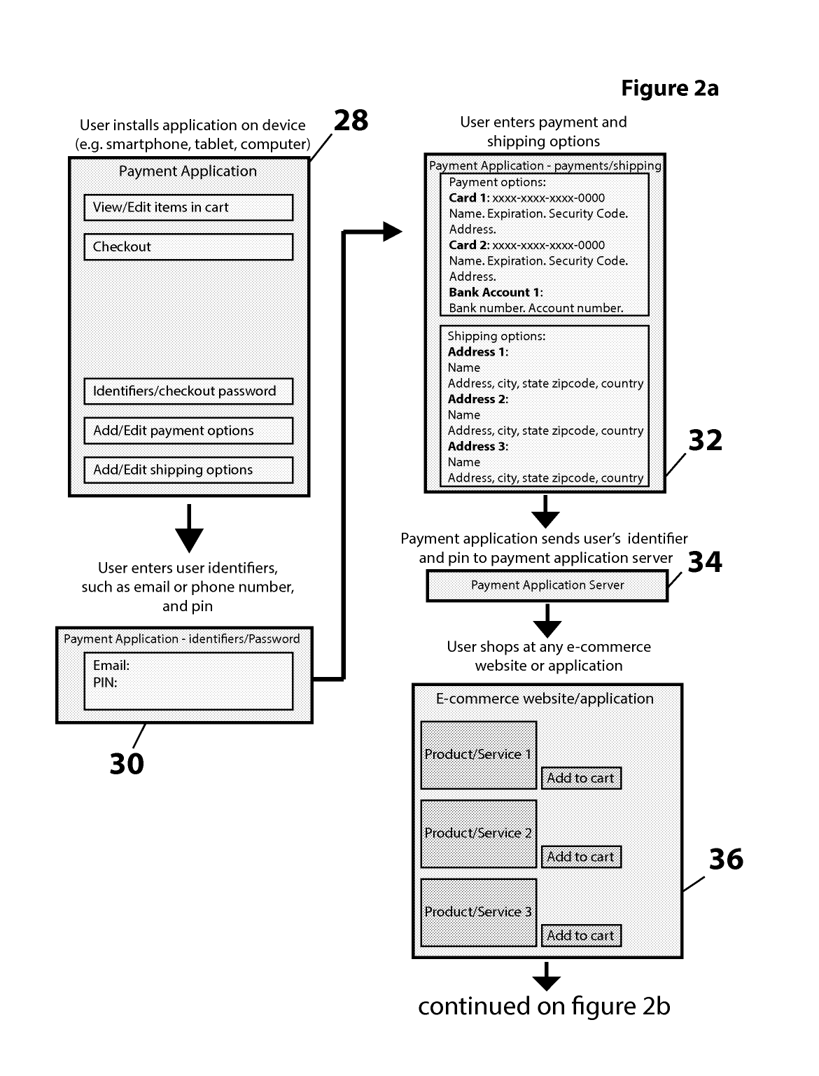

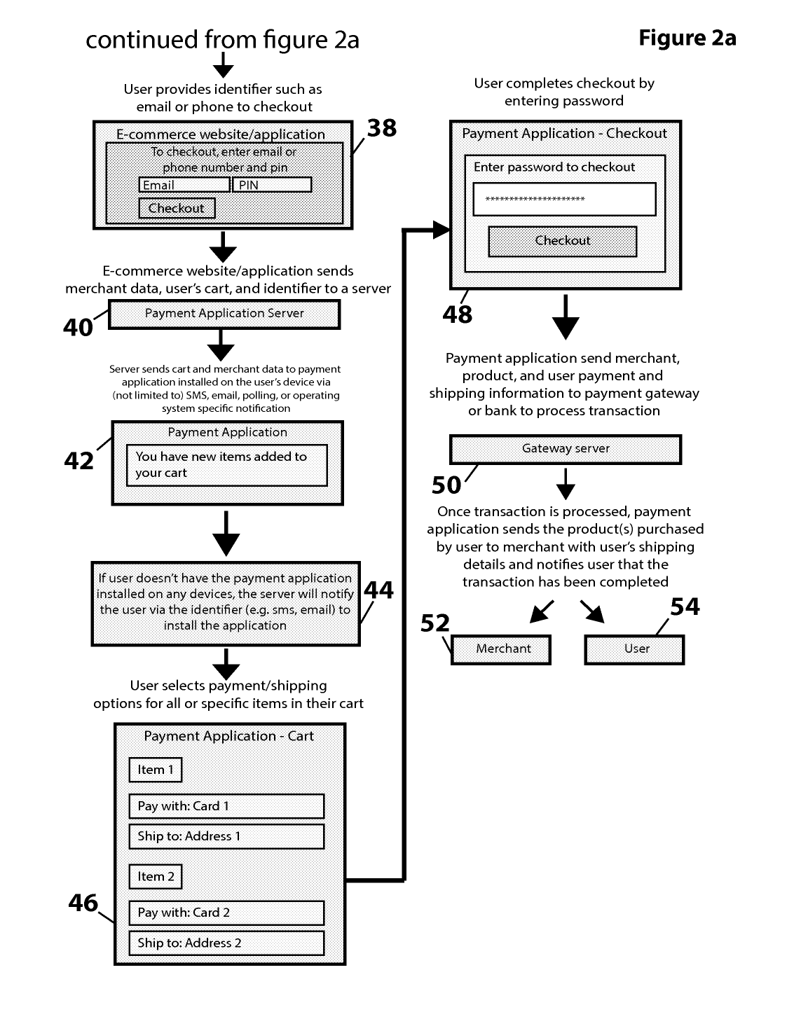

A more detailed overview of the inventive shopping and payment process, as illustrated in FIGS. 2A and 2B, shows the following steps as depicted as follows:
A. Indicium 28: The user installs an application on his or her device (e.g. smartphone, tablet, computer). The payment application inputs the instructions for enabling the specific user to view and edit items placed in that user's shopping cart, to enable the checkout, to place the identifiers/pin password, to add and/or edit the payment and the shipping options.
B. Indicium 30: The user enters user identifiers such as his/her email or phone numbers. The password is later entered with the payment information, with each entered payment method.
C. Indicium 32: The user enters payment and shipping options. Here (1) the payment options, e.g., by credit card and bank account, and (2) the shipping options, such as names and address(es) are identified. With payment information, the user must enter a password for each payment.
D. Indicium 34: The payment application sends the user's identifiers to the application server.
E. Indicium 36: The user shops at any e-commerce website or application. Here the one or more products and/or services are inputted and added to the user's shopping cart.
F. Indicium 38: The user provides the identifier, such as email or phone number, and pin to checkout.
G. Indicium 40: E-commerce website/application sends merchant data, the user's cart, and identifier to the application server.
H. Indicium 42: The server sends cart and merchant data to the payment application installed on the user's device via, but not limited to SMS, email, polling, or operating system specific notification. The payment application identifies any new items that are added to that user's cart.
I. Indicium 44: If the user doesn't have the payment application installed on any device, the application server will notify the user via the identifier (e.g. SMS, email) to install the application.
J. Indicium 46: The user selects payment/shipping options for all or specific items in the user's cart. The payment is as previously instructed, such as by credit card(s) and/or bank account(s).
K. Indicium 48: The user completes checkout by entering his/her password.
L. Indicium 50: The payment application sends merchant, product, and user payment and shipping information to the gateway or bank to process the transaction(s).
M. Indicia 52 and 54: Once the transaction is or the transactions are processed, the payment application (1) sends information of whatever products or services are purchased by the user to the merchant with the user's shipping details and (2) notifies the user that the transaction has been completed.

The exposition as illustrated in FIGS. 1 and 2A, 2B are additionally explained and clarified as follows.

In one embodiment of its implementation, the present invention requires users to install an application onto their individual personal devices. The payment processing software can work as a desktop application, mobile application, web application, or browser add-on. This application will store and manage the user's data on the device. The data stored will include:
A. Personal information and data: E.g. the user's full name, full address, age, username, etc.
B. Shipping information and data: Users may input multiple addresses that any purchase may be shipped to.
C. Payment information and data: A user may input multiple forms of payment such as different credit cards or bank accounts. Payment information is encrypted by password that is not stored on the servers or on any device that holds the payment information, which cannot be decrypted without use of a password. Accordingly, as opposed to current systems, the password is not a gateway to the payment information, but rather the encryption key. This adds an extreme amount of security because, should the device or data be stolen, there is no way for a thief to use that data without the password. The password can comprise a character combination, fingerprint, a retina scan, or a physical token such a USB. Thus, the payment information cannot be decrypted absent a password.
D. Identifiers: The application may try to determine unique identifiers of the user automatically (such as the phone number of the device the application is running on). Users may also manually add identifiers such as email, social security number, phone, etc.

Once a user installs the application on a personal device, an account will be created for them on a application server that maintains user accounts, basic information and data (such as username, and identifiers), and items in their shopping cart.

Users may also use any E-commerce platform participating in the proposed process before installing any additional applications on their personal device. When a user is ready to checkout, the user may use the proposed process by providing an identifier such as the user's email address or phone number. If the user has not installed the proposed application onto any device, the user will be prompted to do so after entering their identifier to checkout.

In one aspect, the invention requires E-commerce establishments, that wish to participate in the proposed process, to add code information and data to their existing or new E-commerce platforms. This code information and data will allow individual users of the platforms to complete the checkout process, after adding items to their carts, by providing a personal identifier such as an email address or phone number. The code information and data that is required to be added may be server-side code information and data that is processed by the platform's server, or front end code information and data, that is processed by the user's device when the user is using the platform.

In another implementation of the invention, no additional code would be required for any E-commerce platform wishing to participate in the proposed process. Instead, users may be required to install an additional application on their device that will automatically add an option to checkout on an E-commerce platform using the proposed process.

When a user completes a checkout on an E-commerce platform, all items in the user's cart are sent to an application server along with the identifier used to checkout. If a user does not have an established account on the application server, that user is prompted to create one by installing the application on a personal device and entering any data required. If the user does have an account established on the application server, the server sends a message, via SMS, email, or operating system specific information, to all devices that have the installed application that matches the identifier entered at the checkout process. Alternatively, applications may poll the application server periodically to see if any items have been added to the users cart and with the identifier entered in the application. A user can shop at multiple merchants (online) before completing check out. At each merchant's site, the user provides the merchant with the user's email or phone number and pin number. The merchant's site then sends (1) the user's information and their cart contents to the application server and (2) the cart contents information to the user's device(s). The transmission (1) always occurs; however, the transmission (2) may not always occur. The user can use the same or different payment method(s) for all items or merchants in their cart, or split the cart in any way to different payment methods and shipping addresses. If a user is shopping on the device that has the application as described herein installed, the user may not have to enter a unique identification (email, phone, security code, etc.).

Because either the application employed herein can monitor the device for the checkout request when a user is shopping at a merchant's site/application, or the merchant's site/application can send a notification to the inventive application on the device that checkout has been requested, the application does not need to verify the identity of the user (therefore not requiring the unique identification and pin from the user since the device is identity enough). A password will still be required to actually pay the merchant via the technological application as described herein. If the application as described in has multiple user accounts on it (e.g., the desktop version of the application is used by multiple members of the family), when checking out at a merchant's site/application, the user will need to enter just the unique identification but not the pin.

When the application on any device receives a message from the server, or has determined that new items are in the user's cart through polling, the application notifies the user on the applicable device that the message and/or new items have been added to his or her cart that any accepted items are ready to be paid for or checked out, so as to enable the checkout process to be completed. The application can notify the user via system alerts or any other notification system available to the operating system on which the application is installed.

Once the application retrieves the items that have been added to the user's cart, the user can enter the application to complete the checkout process. In order to complete the checkout process, the user must have at least one shipping address entered and at least one method of payment. The user may select which payment method to use for any single item, for a group of items, or for all the items. The user may also select which shipping method to use for any single item, group of items or for all items.

Once the shipping and payment methods have been selected, the user may complete the checkout process by entering a signature or password that has been established at the time when the application was installed.

Once the user completes the checkout process in the application, the application will either (1) directly send payment information and data to any one of a single gateway or a multiple of online gateways or to any one of one or more merchant accounts, or (2) send any one or more payments, shipping methods and items in the user's cart to a server.

If the application sends the payment information and data to one or more gateways or merchant accounts, once the application receives a successful response back from such gateways or merchant accounts, the application will notify any merchants or E-commerce platforms of the items in the user's cart that have been (that is, checked out), and that the transaction has been completed. The application will also send the merchants or E-commerce platforms all required shipping information and data selected by the user. The application will also notify the user via SMS, email, phone or any other channel that the transaction has been completed.

If the application sends the payment, shipping, and cart information and data to a server, the server will then communicate with such gateways or merchant accounts and, once a successful response is received from the communicate, the server will notify such merchants and the user that the transaction has been completed. The server will also send any required shipping information and data to such appropriate merchants. In this aspect, Merchant's payment & processing data is stored either on the servers, or on the merchant's servers. When a user wants to checkout, one of two flows are possible:
A. The merchant's data (including it's gateway processor, secret key, merchant identification) is encrypted server-side and then sent to the user's device, which at that time also uses that information to communicate with the merchant's gateway processor or bank and the user's account or bank.
B. Only the merchant's gateway processor or bank identifier is sent from an application server belonging to the application, or the merchant's server to the user's device. The user's device then notifies that processor or bank to initiate a transaction and provides the user's payment information. The processor or bank will respond with a transaction identifier. The user's device then sends this transaction identifier back to the application server belonging to the application or the merchant server which then uses this identifier to communicate with the gateway or bank processor to complete the transaction by providing the transaction identifier, the merchant identification, the secret key, and any other merchant specific information the processor requires.

When the checkout process has been completed in an application, all items that have been paid for may be removed from the application server as well as all applications installed by that user.

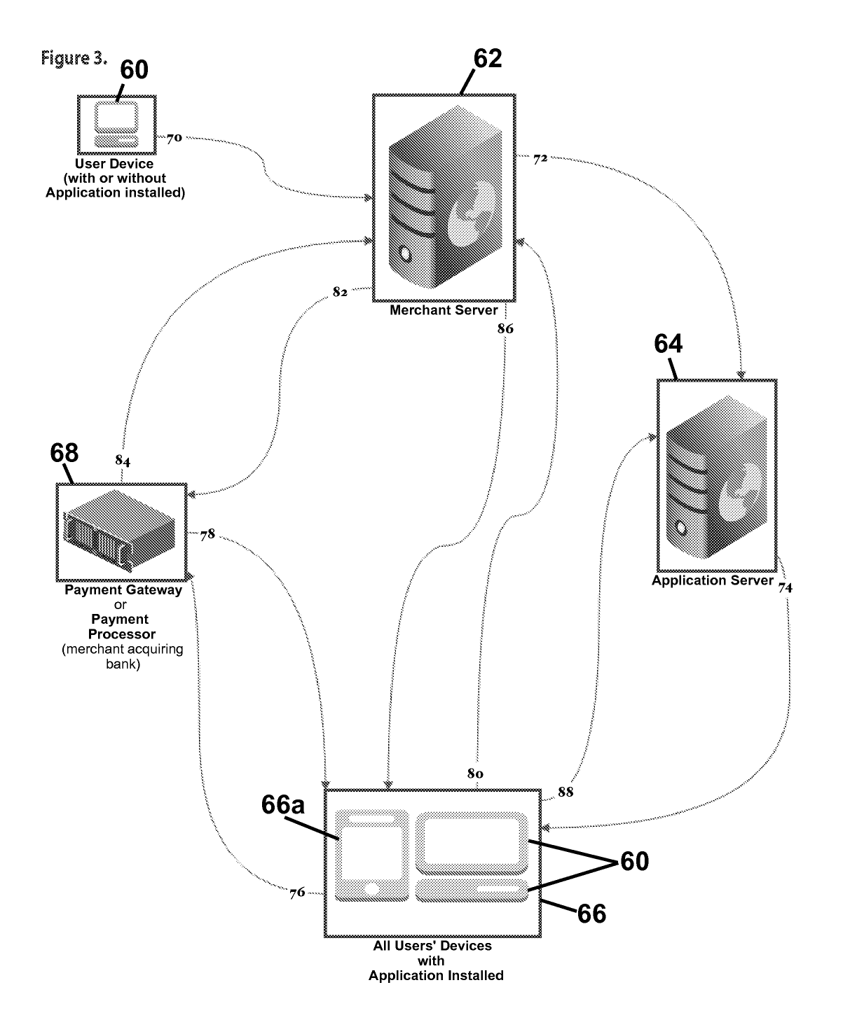

Reference is now made to FIG. 3. In this embodiment, the components include a user device 60 (e.g., a computer) (with or without the application), a merchant server 62, an application server 64, all users' devices 66 with the application such as a smartphone 66a and computer 60, and a payment device 68, such as a payment gateway or a payment processor (e.g., a merchant acquiring bank).

The steps in this embodiment proceed as follows:
A. The user shops at a merchant and then clicks the checkout button, which data is forwarded (generally wirelessly) to merchant server 62 as denoted by transmission line 70.
B. Merchant server 62 sends (generally wirelessly) cart, cart identification, merchant identification, gateway/processor identification, user identification (email), and the user pin to application server 64 as denoted by transmission line 72.
C. Application server 64 sends (generally wirelessly) the cart, merchant, and gateway/processor data to every instance of the application (as denoted by indicium 66) that the user has on any of the user's devices, as denoted by transmission line 74.
D. As denoted by transmission line 76 by which data is sent (generally wirelessly) from device(s) 66 to payment device 68, after a user enters his/her password to complete the checkout, the payment information is decrypted and then re-encrypted according to the requirements of the gateway/processor, as well as the merchant's identification and the charged amount.
E. Payment device 68 (the payment gateway or the payment processor) validates the payment information and checks if the user has enough of a balance to pay the charged amount. The return error/success code and the transaction identification is then returned. This data is transmitted (generally wirelessly) (transmission line 78) from payment device 68 back to all the devices (as denoted by indicium 66).
F. As depicted by transmission line 80, the application sends the transaction and cart identification from device(s) 66 to merchant server 62.
G. Merchant server 62 then sends payment device 68 (the payment gateway or the payment processor) any identifiers or other data to verify identity (such as an account secret key) and the transaction identification as denoted by transmission line 82.
H. As denoted by transmission line 84 to denote the transmission of data from device 68 (the payment gateway or the payment processor) back to merchant server 62, device 68 completes the transaction and returns an error/success code. If “success,” the merchant will process the order as normal.
I. As denoted by transmission line 86 which indicates the transmission of data from merchant server 62 back to device(s) 66, the merchant responds with a success or failure signal and the items in the cart are removed.
J. Finally, as shown by transmission line 88 which shows a transmission from device(s) 66 to application server 64, the application notifies this server that certain items from the cart have been removed.

In the computer implemented method embodied herein, while one of credit card and bank payment information, for example, is encrypted into the user device, the role of a traditional password (which by definition must be stored on the device and compared to what the user enters) is replaced or supplemented by the encryption key, which does not need to be stored on the device. If the user enters anything but the correct key, the attempted decryption of the credit card or bank payment information will result in gibberish and, thus, failure. If the user enters the correct key, such encrypted information is successfully decrypted for being sent to a payment gateway or payment processor (e.g., a merchant bank or credit card processor serving the merchant). Therefore, the decrypting key acts like a password. The decrypting key can comprise a fingerprint, retinal scan, alphanumeric code, or anything else that can be converted into an alphanumeric string.

In operation, the user downloads the software, enters the credit card or bank account number and creates the encryption key, shops, places goods in the cart, pushes the “buy button,” is asked for key, and enters the encryption key. The credit card or bank account number information is then sent to the merchant's merchant bank or credit card processor, after which the merchant and application servers and the user's device are so notified.

Although the invention has been described with respect to one or more particular embodiments thereof, it should be realized that various changes and modifications may be made therein without departing from the spirit and scope of the invention.

What is claimed is:

1. A computer implemented method for enabling users to engage in an E-commerce shopping and payment process utilizing at least one user personal device, comprising the steps of:
(a) utilizing an application server in a computer-based system;
(b) inputting data, including user sensitive information, into the user personal device;
(c) inputting data, including basic user information other than that of the user sensitive information, into the computer-based system which sends the data to the application server to maintain basic user information; and
(d) placing at least one item into a shopping cart.

2. A computer implemented method according to claim 1 further comprising the steps of keying one of encrypted credit card and bank payment information into the user device with a password while preventing said keying from being stored in the user device.

3. A computer implemented method according to claim 1 in which the basic user information comprises identifiers and items in the shopping cart in a database.

4. A computer implemented method according to claim 1, in which said step of placing at least one item into a shopping cart comprises the step of utilizing an e-commerce application.

5. A computer implemented method according to claim 4, in which the e-commerce application comprises a merchant server.

6. A computer implemented method according to claim 1, in which said step of placing at least one item into a shopping cart comprises the step of entering, by the user, of identifying information.

7. A computer implemented method according to claim 6, in which the identifying information includes at least one of phone number and email address information.

8. A computer implemented method according to claim 1, in which said step of inputting data includes the step of installing the application on the personal device so as to store and to provide payment information, to enable items in the cart to be appropriately viewed and edited, to be paid for, to have identifiers entered, and to enable options thereof to be performed.

9. A computer implemented method according to claim 1, in which said step of inputting data, including user sensitive information, into the user personal device comprises the step of storing information including such information as credit card, bank account, shipping instructions, and at least one identifier.

10. A computer implemented method according to claim 9, in which the identifiers include one of phone and email address information.

11. A computer implemented method for enabling users to engage in an E-commerce shopping and payment process including at least one user personal device, comprising the steps of:
utilizing a proprietary server in a computer-based system which computer-based system includes an online shopping system of at least one online merchant;
installing a proprietary application on the user personal device;
entering identifiers into the proprietary application;
storing user's payment information and user's shipping profiles locally in the proprietary application;
implementing a merchant proprietary code in the merchant online shopping system;
upon shopping by the user at any online merchant that has implemented the proprietary code, adding one or more shopped items to the user's cart;
at the time of checkout, entering by the user of one of the user identifiers to complete the checkout process online;
upon completion of the online checkout process, receiving a notification by the user that the user has the one or more shopped items added to the user's cart;
selecting at one of a variety of options for permitting the user to elect a payment method for the one or more shopped items, including the selection of a shipping address to which the one or more shopped items are to be mailed as directed by the device-installed proprietary application;
to complete the transaction and place the order, clicking the checkout button and entering a password by the user into the device-installed proprietary application; and
communicating by the proprietary application with the proprietary server to send the merchant or a merchant agent payment details and to process the transaction so as to notify the merchant of an order notification and the shipping information.

12. A computer implemented method according to claim 11, in which said payment information step comprises the step of utilizing one of a credit card, bank account or like form of payment;
said identifier entering step comprises the step of storing one of a phone number, security code and email;
said notification step comprises the step of utilizing one of email, SMS, operating system specific notification, or like channels that items have been added to their cart; and
said proprietary application communicating is effected by sending the payment details to the merchant or the merchant's bank.

13. A computer implemented method according to claim 11 further comprising the steps of keying one of encrypted credit card and bank payment information into the user device with a password while preventing said keying from being stored in the user device.

14. A computer implemented method for enabling users to engage in an E-commerce shopping and payment process including a user personal device and a proprietary server in a computer-based system which computer-based system includes an online shopping system of at least one online merchant, comprising the steps of:
utilizing at least one merchant server, one application server and payment device;
using the personal device in which a checkout button is included, for enabling a user to shop at a merchant and clicking the checkout button for forwarding data to a merchant server;
transmitting, through the merchant server, data comprising cart, cart identification, merchant identification, payment device identification, user identification, and a user pin to the application server;
transmitting, by the application server, the cart, merchant, and payment device data to the user personal device that the user has and in which personal device the application is installed;
transmitting data from the user personal device to the payment device, after having a user having entered a password to complete the checkout, thus effecting decrypting and re-encrypting of the payment information according to requirements of the payment device, as well as the merchant's identification and the charged amount;
validating the payment information by the payment device and checking if the user has enough of a balance to pay the charged amount to obtain one of a return error and a success code and, then, returning the transaction;
if a return success code is obtained, transmitting the transaction from the payment device back to the personal device;
transmitting by the application the transaction and cart identification from personal device to the merchant server;
transmitting by the merchant server to the payment device of any identifiers or other data to verify identity and the transaction identification;
transmitting data from the payment device back to the merchant server to complete the transaction and to return the error/success code and to process the order as normal if a “success” response is received;
transmitting the data from the merchant server back to the personal device by which the merchant responds with a success or failure signal and to remove accordingly the items; and
transmitting from the personal device to the application server to enable the application to notify the application server that certain items from the cart have been removed.

15. A computer implemented method for enabling users to engage in an E-commerce shopping and payment process including a user personal device and a proprietary server in a computer-based system which computer-based system includes an online shopping system of at least one online merchant, comprising the steps of:
downloading application software;
entering at least one of credit card and bank account number information and creating and entering an encryption key;
encrypting the at least one of credit card and bank account number information using said encryption key;
shopping and placing goods in a cart;
initiating a payment process for the purchase by entering the encryption key;
decrypting the at least one of credit card and bank account number information;
sending the decrypted credit card/bank account number information to one of a merchant's merchant bank and credit card processor; and
effecting notification of merchant and application servers and the user's device.
